(19) United States
(12) Patent Application Publication
(10) Pub. No.: US 2011/0131098 A1
(43) Pub. Date: Jun. 2, 2011

(54) SYSTEM AND METHOD FOR FACILITATING AFFILIATE MARKETING RELATIONSHIPS

(76) Inventors: Jack Bafia, Tinley Park, IL (US); Oliver Roup, San Francisco, CA (US); Raymond Lyle, Chicago, IL (US); Niel Robertson, Boulder, CO (US)

(21) Appl. No.: 12/953,946

(22) Filed: Nov. 24, 2010

Related U.S. Application Data
(60) Provisional application No. 61/265,125, filed on Nov. 30, 2009.
(60) Provisional application No. 61/293,823, filed on Jan. 11, 2010.

(51) Int. Cl. G06Q 30/00

(52) U.S. Cl. 705/14.69

(57) ABSTRACT

Embodiments of the present invention relate to a system and method for facilitating an affiliate marketing relationship. According certain to embodiments of the present invention, an affiliate marketing optimization system enters into an affiliate marketing relationship with a plurality of merchants. In addition, the affiliate marketing optimization system establishes relationships with publishers thereby acting as in intermediary between the publishers and the plurality of merchants. As a result, a publisher may better monetize web traffic by utilizing the affiliate marketing relationships in place between the affiliate marketing optimization system and the plurality of merchants.

### CROSS-REFERENCE TO RELATED APPLICATIONS

This application claims the benefit of U.S. Provisional Patent Application No. 61/265,125, filed Nov. 30, 2009, titled “Web Traffic Monetization Process” and U.S. Provisional Patent Application No. 61/293,823, filed Jan. 11, 2010, titled “System and Method of Late Binding URLs and Merchant Arbitrage,” both of which are herein incorporated by reference.

### FIELD OF THE INVENTION

The present invention relates generally to a method and system for facilitating affiliate marketing relationships. More specifically, embodiments of the present invention relate to a method and system for facilitating affiliate marketing relationships between a publisher and a plurality of merchants.

### BACKGROUND

Affiliate marketing relationships allow publishers of content on the Internet to receive a referral fee based on traffic directed to a merchant. According to an affiliate marketing relationship, when a publisher (i.e., a website or other provider of electronic content) directs a user to a merchant's website (generally via a hyperlink, URL, or web link) and the user makes a purchase from the merchant, the merchant provides the publisher with a referral fee based on the user's purchase. Some merchants may provide a referral fee based on other actions taken by the user, such as the user visiting the merchant's website.

According to conventional implementations of affiliate marketing relationships, a publisher must establish an affiliation or relationship with each merchant for which the publisher wishes to direct traffic in exchange for a referral fee. To do so, the publisher typically creates an account with the merchant which is credited by the merchant with the referral fees allocated to the publisher. In addition, the publisher must integrate tracking information into each uniform resource locator (URL), or web link, which links to the merchant to enable the merchant to correctly identify a given publisher as the source of the web traffic. Further complicating matters, different merchants implement different tracking schemes, thereby forcing publishers to construct customized URLs corresponding to each merchant.

In conventional affiliate marketing programs, publishers are faced with the significant challenge of establishing a merchant-specific account in which referral fees can be allocated, managing the associated merchant-specific protocols and procedures, and configuring a website to include the appropriate tracking codes within any and every merchant URL. As a result, many publishers either do not participate in existing affiliate marketing programs, or only establish affiliate marketing relationships with a small number of merchants. By limiting affiliate marketing relationships to a small number of merchants, publishers often fail to direct users to the merchant who provides the highest referral fee, and therefore publishers fail to optimally monetize their web traffic. For example, two merchants may offer the same television set for sale, however, the first merchant only offers a $10 referral fee while the second merchant offers a $15 referral fee. If the publisher only has an affiliate marketing relationship with the first merchant, the publisher fails to realize $5 of referral fees.

Furthermore, in an instance where a publisher has established affiliate marketing relationships between more than one merchant, the publisher lacks the ability to determine which merchant provides the highest referral fee for web traffic corresponding to the sale of similar or identical products. As a result, even if a publisher has multiple affiliate relationships, conventional implementations of affiliate marketing relationships do not allow the publisher to maximize the value derived from these affiliate relationships. Without a process for establishing affiliate marketing relationships between a publisher and multiple merchants, capable of identifying which of the multiple merchants provides the highest referral fee for a specific product, conventional implementations of affiliate marketing relationships fail to optimally monetize a publisher's web traffic.

Furthermore, conventional implementations of affiliate marketing relationships require a publisher to generate a minimum level of referral fees in order for the merchant to compensate the publisher. For example, a merchant may only compensate publishers who generate over $25 in referral fees in a given month. In such an example, publishers that do not reach this $25 level will not receive any revenue from driving traffic to the merchant's site. As a result, conventional implementations of affiliate marketing relationships fail to compensate publishers that do not meet or exceed a minimum referral fee threshold.

As a result, there is a need in the art for a method and system to established affiliate relationships between a publisher and a plurality of merchants which optimizes the referral fees generated as a result of the affiliate relationships.

### SUMMARY OF THE INVENTION

Embodiments of the present invention satisfy these needs and others by providing a method and system for facilitating affiliate marketing relationships. As used herein, the term “affiliate marketing relationship” includes, but is not limited to, an arrangement wherein an online merchant agrees to compensate parties for driving or directing traffic to a website associated with the online merchant. Compensation may be a referral fee based on any suitable factor, or combination thereof, including but not limited to a portion of sales generated as a result of web traffic directed to the merchant, a number of webpage impressions resulting from the web traffic directed to the merchant, number of clicks a user makes on a merchant's website, or an amount of user information captured by the merchant as a result of the web traffic.

According to certain embodiments of the present invention, an affiliate marketing optimization system, as described in greater detail with reference to FIG. 1, allows an online publisher or website host (collectively referred to as a “publisher”), to take advantage of affiliate marketing relationships with a plurality of merchants without establishing an affiliate marketing relationship with each of the plurality of merchants. As a result, publishers may more easily receive compensation for driving traffic to a merchant.

To assist a publisher in monetizing their referral or outbound/directed web traffic, the affiliate marketing optimization system and method are configured to enter into affiliate marketing relationships with a plurality of merchants and store information related to those relationships. Instead of requiring a publisher to establish an affiliate marketing relationship with the plurality of merchants, the publisher establishes a single relationship with the affiliate marketing optimization system and, as a result, the affiliate marketing optimization system acts as an intermediary between the merchants and the publisher.

According to an embodiment of the present invention, affiliate marketing optimization system is configured to assist and enable the publisher to properly format communications with each merchant as well as facilitate the publisher's receipt of compensation (i.e., referral fees) for web traffic directed to the merchant. According to an embodiment of the present invention, given that the affiliate marketing optimization system provides the publisher with access to a plurality of affiliate marketing relationships, the affiliate marketing optimization system also ensures that the publisher directs web traffic to the merchant which is most likely to provide the highest referral fee, thus optimizing the publisher's referrals and controlling of outbound web traffic.

An embodiment of the present invention provides for transmitting an optimized web link to a publisher by receiving a web link corresponding to a product, identifying plurality of merchants offering the product, calculating an expected referral fee provided by each of the plurality of merchants, identifying, by the computer, an optimal merchant based on the expected referral fee provide by each of the plurality of merchants, generating an optimized web link associated with the optimal merchant; and transmitting the optimized web link to the publisher for display to a user.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary system for facilitating an affiliate marketing relationship, according to an embodiment of the present invention;

FIG. 2 illustrates an exemplary method for facilitating an affiliate marketing relationship, according to an embodiment of the present invention;

FIG. 3 illustrates examples of tables used to calculate expected referral fees, according to an embodiment of the present invention; and

FIG. 4 illustrates examples of web links utilized to facilitate an affiliate marketing relationship, according to an embodiment of the present invention.

### DETAILED DESCRIPTION OF THE DRAWINGS

Embodiments of the present invention relate to a system and method for facilitating affiliate marketing relationships. An affiliate marketing relationship allows a publisher to receive compensation for directing web traffic from the publisher' to a merchant's website. Furthermore, embodiments of the present invention identify the merchant which is expected to generate the greatest compensation for a given publisher (i.e., the highest or optimal referral fee), and facilitates direction of the outbound web traffic from the publisher's website to the identified merchant.

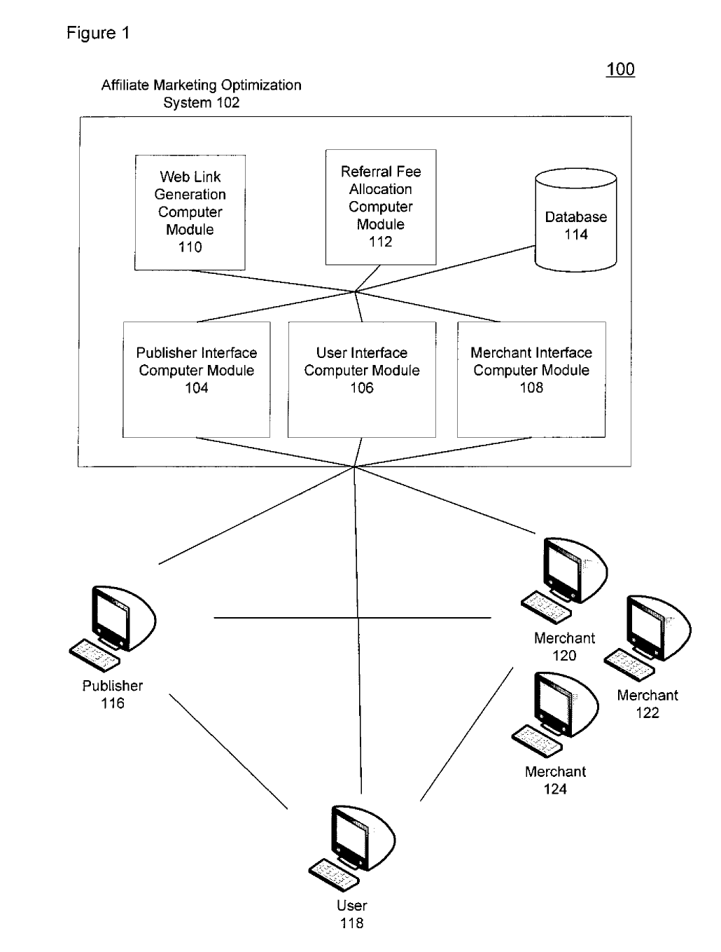

FIG. 1 illustrates an exemplary Data Network 100 comprising an Affiliate Marketing Optimization System 102 according to an embodiment of the present invention. According to an embodiment the present invention, the Affiliate Marketing Optimization System 102 is a web enabled application comprising, a Publisher Interface Computer Module 104, a User Interface Computer Module 106, a Merchant Interface Computer Module 108, a Web Link Generation Computer Module 110, a Referral Fee Allocation Computer Module 112, and a Database 114. The Affiliate Marketing Optimization System 102 is communicatively connected to a Publisher 116, a User 118 and a plurality of Merchants 120-124. As used herein, the term “computer module” is intended to include, but is not limited to, any data processing device, such as a desktop computer, a laptop computer, a mainframe computer, a personal digital assistant, a server, a handheld device, or any other device able to process data and is configured to execute one or more software programs configured to perform one or more functions as described in detail below. The aforementioned components of the Data Network 100 and the Affiliate Marketing Optimization System 102 represent computer hardware and computer-implemented software configured to perform the functions described in detail below. One having ordinary skill in the art will appreciate that the components of the Affiliate Marketing Optimization System 102 may be implemented on one computer or multiple communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers. FIG. 1 illustrates an exemplary environment wherein the Affiliate Marketing Optimization System 102 is connected to only one user (User 118) and publisher (Publisher 116), and multiple merchants (Merchants 120-124), however any number of users, publishers and merchants may be connected to and interact with the Affiliate Marketing Optimization System 102.

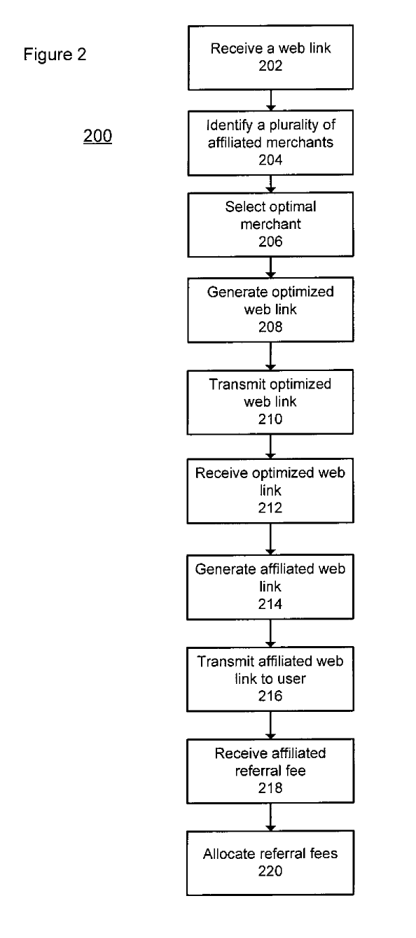

The features and functionality according to embodiments of the Affiliate Marketing Optimization System 102 and its components are described in detail in connection with the system diagram of FIG. 1 and the process flow diagram of FIG. 2. As illustrated in FIG. 1, one or more user computers (e.g., User 118) are communicatively connected to the Publisher 116, the Merchants 120-124, and the Affiliate Marketing Optimization System 102. As used herein, the Publisher 116 may include any website or electronic resource provider configured to delivered content to the User 118. For example, the Publisher 116 may be an online newspaper configured to transmit electronic news articles to the User 118. The Merchants 120-124 may be any e-commerce website selling any product, wherein a product may include any goods or services available for purchase.

According to an embodiment of the present invention, the Affiliate Marketing Optimization System 102 enters into and maintains an affiliate marketing relationship with each Merchant 120-124. Given that the Affiliate Marketing Optimization System 102 establishes the affiliate marketing relationship with each Merchant 120-124, the Publisher 116 need not establish an affiliate marketing relationship with each Merchant 120-124. Instead, the Publisher 116 creates an account with the Affiliate Marketing Optimization System 102 and the Affiliate Marketing Optimization System 102 acts as an intermediary between the Publisher 116 and each Merchant 120-124.

According to the embodiment of the present invention, as illustrated in FIG. 2, method 200 begins at step 202, wherein the Affiliate Marketing Optimization Systems 102, specifically the Publisher Interface Computer Module 104 communicatively connected to the Publisher 116, receives a web link from the Publisher 116. The term “web link” is intended to include, but is not limited to, a uniform resource locator, or other electronic pointer, used to identity the location of a webpage or other electronic recourse located on a remote computer. To facilitate the interaction between the Publisher 116 and the Affiliate Marketing Optimization System 102, Affiliate Marketing Optimization System 102 provide a web link identification handler, or portion of computer code, to the Publisher 116 for installation on the computer system or servers of the Publisher 116 configured to serve content. In response to a request by the User 118 for a webpage of the Publisher 116, the web link identification handler reviews the requested webpage prior to delivery to the User 118. The web link identification handler reviews the webpage for web links directed to merchants with which the Affiliate Marketing Optimization System 102 has an established affiliate marketing relationship (i.e., an affiliated merchant). The term “affiliated merchant” is intended to include, but is not limited to, a merchant having established relationships with the Affiliate Marketing Optimization System 102 under which the merchant provides a referral fee as a result of web traffic directed to the merchant. When the web link identification handler recognizes a web link directed to an affiliated merchant, the Publisher 116 forwards the web link to the Affiliate Marketing Optimization System 102, which receives the web link at step 202. The web link identification handler may be a portion of Javascript embedded within the HTML code of the Publisher 116 which loads in conjunction with each requested webpage. Alternatively the web link identification handler may be a portion of code that executes within the server environment of the Publisher 116, for example, but not limited to, PHP, Java or Python.

Following the receipt of the web link from the Publisher 116, method 200 continues at step 204 wherein a plurality of affiliated merchants are identified. Despite the fact that the web link has been identified as corresponding to an affiliated merchant (e.g., for example the Merchant 120) that the merchant may not necessarily provide the Publisher 116 with the best referral fee from among all affiliate merchants. To optimize an excepted referral fee associated with traffic generated by the Publisher 116, the Web Link Generation Computer Module 110 is configured to first identify the product corresponding to the web link. Based on the identified product, the Web Link. Generation Computer Module 110 determines which affiliated merchants are offering the product for sale. According to certain embodiments of the present invention, the Web Link Generation Computer Module 110 queries a database of products assembled from one or more of the following sources, a merchant provided product catalog, a product catalog obtained by “scraping” the publicly accessible data of a merchant or a catalog provided by a third party, such as, for example, Channel Intelligence, TheFind, Google Product Search, PriceGrabber, or other like provider. This database is then consulted to determine which merchants currently offer the product for sale and the terms of the offer. The Web Link Generation Computer Module 110 refines the list of merchants found to offer the product for sale by selecting affiliated merchants from the list of merchants, thereby identifying the plurality of affiliated merchants, at step 204 of method 200.

Based on the plurality of affiliated merchants, method 200 continues by selecting the optimal merchant from among the plurality of affiliated merchants, at step 206 of method 200. According to certain embodiments of the present invention, the optimal merchant is the merchant with the highest expected referral fee for a given product. The expected referral fee may be based on the price of the item, payout rate provided by the given merchant, estimated conversion rate, merchant reputation, expected duration of the product listing and/or other factors. Duration of a product listing may be important when a merchant stops selling a product when the product is no longer new (i.e., Amazon.com) or when an auction expires (i.e., eBay.com). The price of the item is retrieved by the Web Link Generation Computer Module 110 by querying the one or more online product listing services. Despite the fact that each of the plurality of affiliated merchants is offering the same product for sale, different merchants may offer a different sale price for the same product.

According to certain embodiments of the present invention, the Web Link Generation Computer Module 110 also relies on the payout rate for each Merchant 120-124 when calculating the expected referral fee. The payout rate represents the percentage of commission paid by a merchant when a publisher directs a user to the merchant and as a result the user purchases a product from the merchant. For example, Merchant 120 may provide a 3% payout rate on the sale price of a television if the Publisher 116 directs the User 118 to the Merchant 120 to purchase the television.

According to certain embodiments of the present invention, the User 118 may not be required to complete the purchase immediately after following a web link from the Publisher 116 to the Merchant 120. Through use of Internet cookies saved on the computer of the Uscr 118, a purchase made by the User 118 may still be credited to the Publisher 116 if the User 118 makes a purchase within a specified period of time. For example, the Publisher 116 may be credited for a purchase provided the User 118 completes the purchase from the Merchant 120 within fifteen days of the User 118 following a web link supplied by the Publisher 116.

According to an embodiment of the present invention, the Web Link Generation Computer Module 110 utilizes a conversion rate estimation when calculating an expected referral fee. The conversion rate estimation represents the likelihood a User 118 will complete a purchase if directed to a specific merchant. For example, a conversion rate estimation represents the probability the User 118 will follow a web link provided by the Publisher 116 and actually complete a purchase of a corresponding product. Given that a Publisher 116 may only receive a referral fee in the event a User 118 completes a purchase, the Publisher 116 has an interest in assessing the probability of the User 118 completing a purchase from each of the Merchants 120-124. According to certain embodiments of the present invention, the conversion rate estimation may be based on a historical conversion rate, a geographic relevance, and/or a psychographic match. The historical conversion rate represents the frequency with which users have been directed to and complete a purchase from the given merchant. The geographic relevance reflects the frequency with which geographically similar users have completed a purchase from a given merchant. Geographic relevance may be important when merchants have certain brand loyalty in a given geographic region, or where currency conversion may be an issue. According to certain embodiments of the present invention, the data used to calculate the conversion rate estimation may be collected from previous transactions facilitated by the Affiliate Marketing Optimization System 102 and stored in the Database 114. The Publisher 116 may provide information about the User 118 (e.g., location, web browsing history, etc) to the Affiliate Marketing Optimization System 102 for use when calculating the conversion rate estimation. Finally, a psychographic match may rely on data mining to identify buying patterns. By way of example, analyzing buying patterns might indicate that men 25-45 prefer to buy electronics from BestBuy.com when there is a BestBuy location nearby. However, women of all ages and anyone living more than 25 miles to the nearest BestBuy location often fail to complete a purchase from BestBuy.com. Data mining may be conducted based on information stored in the Database 114 or could be conducted through use of outside information by a third party, such as, for example BlueKai or RapLeaf.

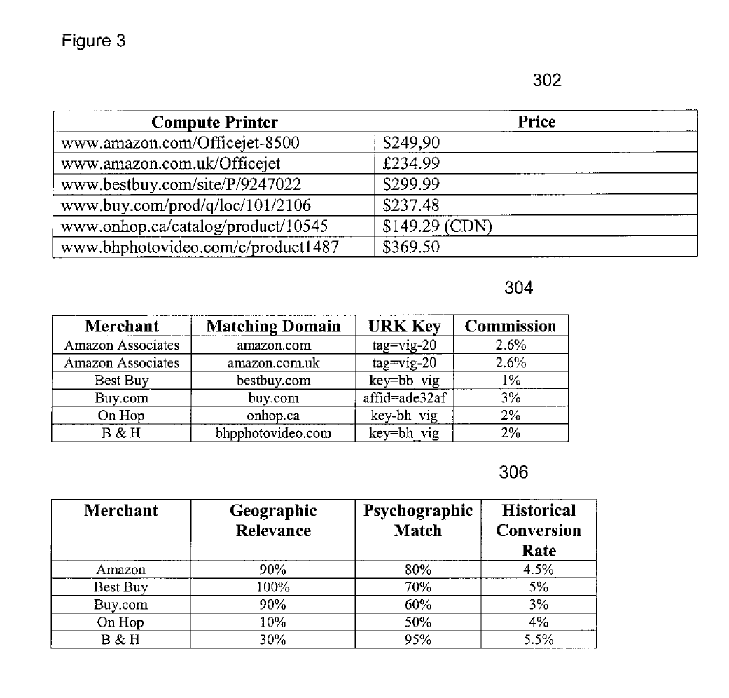

According to certain embodiments of the present invention, after identifying the sale price, determining the payout rate, and calculating the conversion rate estimation, the expected referral fee is calculated based on these figures. According such an embodiment of the present invention, the expected referral fee is calculated by multiplying the sale price by the payout rate by the conversion rate estimation. By way of example, FIG. 3 illustrates a sale price table 302, a payout rate table 304, and a conversion rate estimation table 306. The tables 302-306 correspond to the sale of a computer printer. Based on tables 302-306, the expected referral fee for Amazon.com is $0.21, based on the following calculation, represents $249.90 multiplied by a referral fee of 2.6% and the conversion rate estimation of 3.24% (i.e., 90%×80%×4.5%). In comparison, the expected referral fee for BestBuy.com is $0.10, based on the following calculation, represents $299.90 multiplied by a referral fee of I% and the conversion rate estimation of 3.5% (i.e., 100%×70%×5%). As a result, Amazon.com has a higher expected referral fee than BestBuy.com for the specific printer. It is important to note that the expected referral fee is not necessarily equal to the actual referral fee paid by Amazon.com if a user purchases the printer. In this example, the actual referral fee would be $6.50, however, when calculating the expected referral fee, the actual referral fee of $6.50 is significantly discounted based on the convention rate estimation, primarily due to the historical conversion rate. According to alternative embodiments of the present invention, the sale price, the payout rate and the conversion rate estimation may not all be relied on to calculate the expected referral fee. Alternatively, the expected referral fee may be calculated based on inputs in addition to, or instead of, the sale price, the payout rate and the conversion rate estimation, such as, for example, the webpage a user arrives to a merchant from which could imply certain demographics, the income level implied by a user's geography, cookie history and data purchased from a third party.

According to certain embodiment of the present invention, the Merchant 120-124 with the highest expected referral fee is identified as the optimal merchant. In such an embodiment, the optimal merchant represents the merchant likely to provide the highest referral fee for web traffic directed from the Publisher 116 for a particular transaction or potential transaction. As a result, in this example, Amazon.com would be selected as the optimal merchant according to the information provided in FIG. 3 and the aforementioned calculation.

According to alternative embodiments of the present invention, the expected referral fee may not be the only factor considered when selecting an optimal merchant. As described above, the Affiliate Marketing Optimization System 102 established an affiliate relationship with each of the Merchants 120-124 and as a result, the Publisher 116 need only create an account with the Affiliate Marketing Optimization System 102. Because of this arrangement, each Merchant 120-124 views web traffic generated by the publishers utilizing the Affiliate Marketing Optimization System 102 as originating from the Affiliate Marketing Optimization System 102. By aggregating the web traffic of the publisher, the Affiliate Marketing Optimization System 102 allows smaller publishers (i.e., publishers that do not have a high volume or aggregate base for a referral fee) that may not otherwise meet minimum revenue requirements defined by the Merchants 120-124 to receive some compensation for web traffic directed from the publisher to the Merchants 120-124. In addition to defining minimum revenue requirements, some merchants provide bonuses in the event that traffic directed from a single affiliate results in a specified amount of sales. For example, the Merchant 122 may provide a $2,000 bonus to any affiliate that directs web traffic to the Merchant 122 within a month resulting in $250,000 in sales. Given that the Merchants 120-124 view the Affiliate Marketing Optimization System 102 as a single affiliate, the Affiliate Marketing Optimization System 102 may qualify for certain bonuses based on the aggregate sales stemming from web traffic originating from a plurality of individual publishers. The operator of the Affiliate Marketing Optimization System 102 may retain the bonuses or distribute the bonuses among one or more of the publishers that utilize the Affiliate Marketing Optimization System 102. As a result, according to certain embodiments of the present invention, the Affiliate Marketing Optimization System 102 may factor in the likelihood of receiving a bonus, the size of the bonus, and/or the proximity to qualifying levels for receiving a bonus, when selecting the optimal merchant.

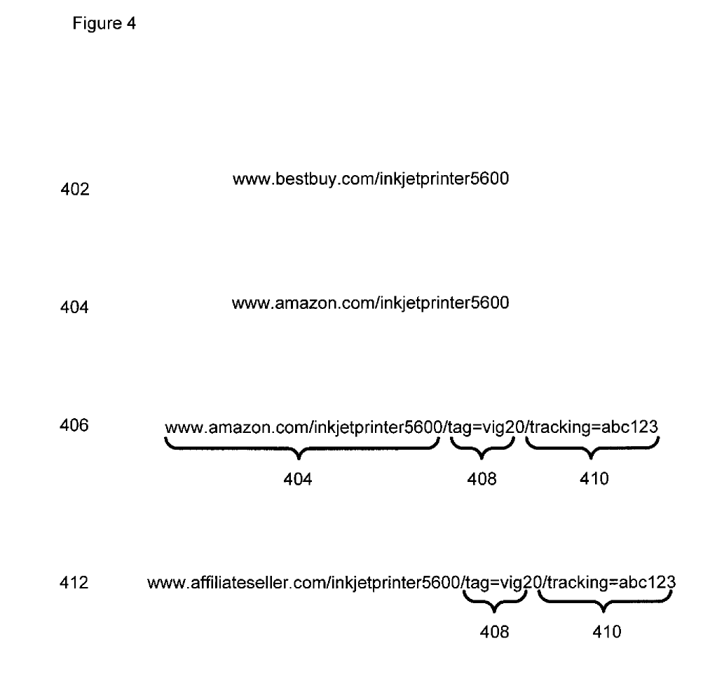

Following the selectipn of the optimal merchant at step 206, method 200 continues by generating the optimized web link, at step 208. The optimized web link represents the web link corresponding to the requested product webpage of the optimal merchant. Therefore, the Web Link Generation Computer Module 110 generates a web link to be included in the webpage of the Publisher 116 which when interacted with (e.g., clicked on) directs the User 118 to the optimal merchant. As illustrated in FIG. 4 and in accordance with the previous example, the original web link 402 provided by the Publishers 116 would have directed the User 118 to an offer for a printer at BestBuy.com. However, as described above, Amazon.com was determined to be the optimal merchant for the printer by the Affiliate Marketing Optimization System 102. Therefore, the Affiliate Marketing Optimization System 102 generates and optimized web link 404 which will direct the User 118 to Amazon.com. The optimized web link is then transmitted to the Publisher 116 and included in the webpage requested by and served to the User 118.

According to certain embodiments of the present invention, the User 118 receives a webpage from the Publisher 116 wherein the webpage includes one or more optimized web links. In addition to including the one or more optimized web links, the Publisher 116 includes a web link handler within the code of the webpage. The web link handler is configured to respond to certain actions of the User 118 (i.e., the user clicking on an optimized web link) by triggering communications with the Affiliate Marketing Optimization System 102, resulting in the creation of an affiliated web link. An affiliated web link is a URL directed to an affiliated merchant wherein the URL is formatted to allow the merchant to associate any web traffic resulting from the affiliated web link with a specific source. The affiliated web link serves to identify the Affiliate Marketing Optimization System 102 to the merchant and allow the Affiliate Marketing Optimization System 102 to identify a specific publisher. By associating the web traffic with a specific source, the merchant can properly credit any referral fee to the appropriate entity. According to an embodiment of the present invention, an affiliated web link is formatted to signal to the Merchants 120-124 that the Affiliate Marketing Optimization System 102 is the source of any web traffic, despite the fact the User 118 actually followed an affiliated web link located on a webpage of the Publisher 116. As described above, the Affiliate Marketing Optimization System 102 is able to act as an intermediary between the Publisher 116 and the Merchants 120-124.

According to certain embodiments of the present invention, the web link handler is configured to respond when the User 118 clicks on an optimized web link by communicating with the Affiliate Marketing Optimization System 102 to retrieve an affiliated web link. Instead of allowing the User 116 to proceed directly to the destination of the optimized web link, the web link handler captures the clicked-on optimized web link and transmits the optimized web link to the Affiliate Marketing Optimization System 102. According to alternative embodiments of the present invention, the web link handler may be triggered by the User 118 mousing over an optimized web link, or any other similar user initiated action. The web link handler may he constructed through the use of JavaScript, executing on a web browser, as well as, server side technologies, such as, for example PHP, Java, Perl, Python, or other link technologies.

The Affiliate Marketing Optimization System 102, more specifically the User Interface Computer Module 106, is configured to receive the optimized web link at step 212 of method 200 and generate a corresponding affiliated web link at step 214. To generate an affiliated web link, the Web Link Generation Computer Module 110 first identifies the affiliated merchant for which the optimized web link is directed, given that each affiliated merchant may require the affiliated web link to be formatted in a specific manner. When establishing the affiliate marketing relationship between the Affiliate Marketing Optimization System 102 and the Merchants 120-124, each Merchant 120-124 provides to the Affiliate Marketing Optimization System 102 the format used to generate an affiliated web link. For example, a Merchant 120 may assign the Affiliate Marketing Optimization System 102 with an identification code which uniquely identifies the Affiliate Marketing Optimization System 102. In this example, the Affiliate Marketing Optimization System 102 may create an affiliated web link by appending the identification code to a web link directed to the Merchant 120. As result, when the Merchant 120 receives the affiliated web link, the Merchant 120 associates the web traffic with the Affiliate Marketing Optimization System 102 based on the identification code. As illustrated in FIG. 4, an affiliated web link 406 is generated by appending the Affiliate Marketing Optimization System 102 identification code 408 to the end of the optimized web link 404. As a result, Amazon.com can correctly identify the source of the web traffic (i.e., Affiliate Marketing Optimization System 102) based on the affiliated web link 406.

According to certain embodiments of the present invention, the Affiliate Marketing Optimization System 102 also appends a tracking code to the affiliated web link. The tracking code is for use by the Referral Fee Allocation Computer Module 112 of the Affiliate Marketing Optimization System 102 when allocating any referral fee paid by the Merchants 120-124 to the appropriate publisher. Given that each Merchant 120-124 views the Affiliate Marketing Optimization System 102 as the single source of the web traffic generated by the Publisher 116 utilizing the Affiliate Marketing Optimization System 102, the Merchants 120-124 provide an affiliated referral fee payment to the Affiliate Marketing Optimization System 102 as a result of the web traffic. To ensure each publisher receives their appropriate portion of the affiliated referral fee payment, a tracking code may be included in the affiliated web link thereby associating a given affiliated web link to a specific publisher. According to such an embodiment of the present invention, the affiliated referral fee provided by the Merchants 120-124 includes an itemized list of all referral fees included in the affiliated payment and the tracking code associated with each referral fee. This itemized list allows the Affiliate Marketing Optimization System 102 to effectively allocate each referral fee to the corresponding publisher, as discussed further below in reference to step 220 of method 200. As illustrated in FIG. 4, the affiliated web link 406 include a tracking code 410 which will be used when allocating individual referral fees to the appropriate publisher. According to an alternative embodiment of the present invention, some merchants do not provide tracking codes or the provided tracking codes are insufficient for certain publishers. For example, Amazon limits the use tracking codes to only a few thousand per publisher. As a result, referral fees may be allocated proportionately based on inbound clicks directed to a merchant.

According to an alternative embodiment of the present invention, the Merchants 120-124 may require web traffic related to an affiliate marketing relationship to be directed to a domain other than the domain wherein traffic not related to an affiliate marketing relationship is directed. As result, generating an affiliated web link may include more than appending the affiliate identification code 408 and the tacking code 410 to the optimized web link. As illustrated in FIG. 4, affiliated web link 412 corresponds to optimized web link 404 however the User 118 is directed to a website domain other than www.Amazon.com. Instead, the User 118 is directed to affiliate.affiliateamazon.com. The affiliated web link 412 still utilizes the affiliate identification code 408 and the tracking code 410 as described above.

Following the creation of the affiliated web link at step 214, the affiliated web link 412 is transmitted to the web link handlers located on the computer of the User 118, at step 216. According to an embodiment of the present invention wherein the web link handler retrieves the affiliated web link 412 in response to the User 118 clicking an optimized web link, the web link handler receives the affiliated web link and directs the User's 118 web browser to the location prescribed by the affiliated web link. Rerouting the web browser of the User 118 from the location dictated by the optimized web link to the location dictated by the affiliated web link occurs without any additional action by the User 118. As a result, despite the fact that the User 118 clicked on the optimized web link, the User 118 is directed to the web page associated with the affiliated web link. Once the User 118 is provided with the web page associated with the affiliated web link, the User 118 is free to browse the corresponding webpage, as well as additional webpages.

Certain affiliate merchants do not track affiliate traffic to all webpages on the affiliate merchant's website, relying instead on cookies embedded in special “landing pages.” As a result, web traffic which does not arrive at a landing page may not be tracked. To ensure that user traffic is accounted from when users are directed to non-landing pages, according to alternative embodiments of the present invention, users are directed to a webpage containing the landing page in a small or hidden section of the webpage corresponding to the affiliated web link. As a result, the cookie from the landing page will still track the users however the user will view the webpage corresponding to the affiliated web link and may be unaware that a landing page was also activated.

According to alternative embodiments of the present invention, the web link handler may request an affiliated web link in response to the User 118 mousing over an optimized web link (i.e., positioning the pointer of the web link). As a result, when the User 118 mouses over an optimized web link, the web link handler forwards the optimized web link to the Affiliate Marketing Optimization System 102 wherein the affiliated web link is generated and transmitted to the web link handlers, as described above. In such an embodiment wherein the web link handler is triggered by a mouse over event, the web link handler is configured to receive the affiliated web link and redirect the User 118 to the associated location when the User 118 clicks the optimized web link. Retrieving the affiliated web link prior to the User 118 clicking the optimized web link may reduce latency in redirecting the User 118 caused by the lag between the web link handlers requesting the affiliated web link and the web link handler receiving the affiliated web link.

Alternatively, in order to further reduce latency, the rendering of optimized web links into affiliated web links may be done prior to a mouse over event. Web links may be affiliated before mouse over, on the speculation that a mouse over may soon occur and latency would be further reduced at the cost of affiliating a link that may never be clicked. Further, the affiliation could be done before the page is ever delivered to a user. Affiliating a link prior to delivering a webpage to a user would reduce latency even further and would eliminate having to rely on technologies like Javascript or the complexity of interacting with other Javascript that might already exist on the web page.

According to the embodiment of the present invention illustrated in FIG. 2, method 200 continues by receiving an affiliated referral fee payment, at step 218. An affiliated referral fee includes referral fees corresponding to a given affiliate marketing relationship between a Merchant 120 and the Affiliate Marketing Optimization System 102. In instances wherein the Affiliate Marketing Optimization System 102 has generated a plurality of affiliated web links directed to the Merchant 120, the affiliated referral fee includes any referral fee that arises from the action of users that follow the plurality of affiliated web links. To minimize the need for the Merchant 120 to transmit a referral fee immediately following each user action which produces a referral fee, the Merchants 120-124 aggregates all referral fees corresponding to a given affiliate marketing relationship and provides a single affiliated referral fee within certain intervals. The intervals may be defined by a time (i.e., 30 days, 60 days) or by a minimum dollar amount (i.e., once the aggregate of all referral fees reaches $150). The affiliated referral fee includes an itemized list of each included referral fee with the corresponding tracking code. The tracking code identifies the specific web link responsible for the given referral fee. The funds associated with the affiliated referral fee may be transferred via wire transfer, PayPal, or other payment method, from the Merchants 120-124 to the Affiliate Marketing Optimization System 102, or financial institutions responsible for the funds corresponding to the Merchants 120-124 and the Affiliate Marketing Optimization System 102.

According to an embodiment of the present invention, depending on the terms of the affiliate marketing relationship between the Merchants 120-124 and the Affiliate Marketing Optimization System 102, the Merchant 120 may provide a referral fee based on the amount of time the User 118 spends browsing the Merchants' 120-124 website, any purchases made by the User 118 from the Merchants' 120-124 website, any information the User 118 provides to the Merchant 120 (e.g., email address, telephone number), or any other action defined by the affiliate marketing relationship. The Merchant 120 may base the referral fee on any actions by the User 118 which occur within a defined period of time, starting from the point at which the User 118 follows the affiliated web link to the website of the Merchant 120.

As illustrated in FIG. 2, the affiliated referral fee is received at step 218, and the Referral Fcc Allocation Computer Module of the Affiliate Marketing Optimization System 102, 112 allocates portions of the funds included in the affiliated referral fee to the appropriate publisher, at step 220. To allocate the affiliate referral fee payment, the Referral Fee Allocation Computer Module 112 associates each referral fee included in the affiliated referral fee payment with an affiliated web link based on a tracking code. Given that each tracking code is unique to a specific publisher, a referral fee can be effectively allocated to the appropriate publisher by matching the tracking code with the publisher. According to an embodiment of the present invention, the funds for each referral fee may be transmitted by the Affiliate Marketing Optimization System 102 to the corresponding publisher, a financial institution of the publisher, PayPal account, or to an account maintained by the Affiliate Marketing Optimization System 102 on behalf of the publisher. In an alternative embodiment of the present invention, the Publisher 118 may elect to receive a referral fee in the form of a gift card for use at an affiliate merchant or other non-affiliated merchants.

According to certain embodiments of the present invention, the Affiliate Marketing Optimization System 102 may retain a portion of one or more referral fees as a service charge. This service charge may be a flat fee for each referral fee, a percentage of each referral fee, a monthly fee, or any other fee sharing arrangement.

According to alternative embodiments of the present invention, the optimized web link may be affiliated prior to transmitting the optimized web link to the Publisher 118. In other words, when the optimized merchant is selected, an affiliated web link is created and this affiliated web link is transmitted to the Publisher 116 for display to the User 118. As a result, there is no need to affiliate the optimized web link, as described in method 200. Therefore, when the User 118 clicks a web link provided by the Publisher 118, the web link already contains the affiliate identification code and tracking code, and the User 118 is sent directly to the corresponding website.

According to an additional alternative embodiment of the present invention, the Affiliate Marketing Optimization System 102 may receive a web link from the Publisher 116 and create an affiliated web link without identifying an optimal merchant. This is an example wherein the Affiliate Marketing Optimization System 102 receives a web link directed to an affiliated Merchant 122. The Affiliate Marketing Optimization System 102 then creates an affiliated web link directed to the Merchant 122. According to such an embodiment, the Affiliate Marketing Optimization System 102 does not determine if the Merchant 122 is the optimal merchant. For example, the Affiliate Marketing Optimization System 102 may receive a web link directed to the sale of a camera by BestBuy.com. According to such an embodiment of the present invention, the Affiliate Marketing Optimization System 102 does not determine if other Merchants 120 or 124 would provide a higher expected referral fee than BestBuy.com. Instead, an affiliated web link is generated directed to BestBuy.com, and the affiliated web link is transmitted to the Publisher 116.

According to certain embodiments of the present invention, the Affiliate Marketing Optimization System 102 may be configured to create an optimized web link directed to a product similar to the product identified in a web link provided by the Publisher 116. In such an embodiment, the Affiliate Marketing Optimization System 102 may identify a similar product to the product identified in the web link and optimize the web link by directing the User 118 to the similar product. The product may be similar while providing better pricing, more features, or an updated model, as compared to the originally requested product.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A computer implemented method for transmitting an optimized web link to a publisher, comprising:
receiving, by a computer, a web link corresponding to a product;
identifying, by the computer, a plurality of merchants offering the product;
calculating, by the computer, an expected referral fee provided by each of the plurality of merchants;
identifying, by the computer, an optimal merchant based on the expected referral fee provided by each of the plurality of merchants;
generating, by the computer, an optimized web link associated with the optimal merchant; and
transmitting, by the computer, the optimized web link to the publisher for display to a user.

2. The computer implemented method of claim I, further comprising:
receiving a request from the user for an affiliated web link corresponding to the optimized web link;
generating the affiliated web link comprising:
a web address of the optimal merchant, and
a tracking code corresponding to the publisher; and
transmitting the affiliated web link to the user.

3. The computer implemented method of claim 2, further comprising:
receiving from the optimal merchant an affiliated referral fee payment comprising:
one or more referral fees, and
a tracking code corresponding to each of the one or more referral fees; and
allocating to the publisher at least one of the one or more referral fees based on the tracking code.

4. The computer implemented method of claim 3 wherein a service fee is removed from the one or more referral fees.

5. The computer implemented method of claim 1 wherein the expected referral fee comprises a geographic relevance.

6. The computer implemented method of claim 1 wherein the expected referral fee comprises an historical conversion rate.

7. The computer implemented method of claim 1 wherein the optimal merchant has the highest referral fee from among the plurality of merchants.

8. A computer implemented method for allocating a referral fee to a publisher, comprising:
receiving, by a computer, a request for an affiliated web link corresponding to a merchant offering a product;
generating, by the computer, the affiliated web link comprising:
a web address of the merchant, and
a tracking code corresponding to the publisher;
transmitting, by the computer, the affiliation web link for display to the user;
receiving, by the computer, an affiliated referral fee payment from the merchant comprising:
one or more referral fees, and
a tracking code corresponding to each of the one or more referral fees; and
allocating to the publisher at least one of the one or more referral fees based on the tracking code.

9. A system for transmitting an optimized web link to a publisher, comprising:
a publisher interface computer module configured to:
receive a web link corresponding to a product;
transmit the optimized web link to the publisher for display to a user; and
a web link generation computer module communicatively connected to the publisher interface computer module configured to configure to:
identify a plurality of merchants offering the product;
calculate, an expected referral fee provided by each of the plurality of merchants;
identify an optimal merchant based on the expected referral fee provided by each of the plurality of merchants; and
generate an optimized web link associated with the optimal merchant.

10. The system of claim 9, further comprising a user interface computer module configure to:
receive a request from the user for an affiliated web link corresponding to the optimized web link; and
transmit the affiliated web link to the user;
and the web link generation computer module is configured to generate the affiliated web link comprising:
a web address of the optimal merchant, and
a tracking code corresponding to the publisher.

11. The system of claim 10, further comprising a merchant interface computer module configured to:
receive from the optimal merchant an affiliated referral fee payment comprising:
one or more referral fees, and
a tracking code corresponding to each of the one or more referral fees; and
a referral fee allocation computer module configured to:
allocate to the publisher at least one of the one or more referral fees based on the tracking code.

12. The system of claim 11 wherein a service fee is removed from the one or more referral fees.

13. The system of claim 9 wherein the expected referral fee comprises a geographic relevance.

14. The system of claim 9 wherein the expected referral fee comprises an historical conversion rate.

15. The system of claim 9 wherein the optimal merchant has the highest referral fee from among the plurality of merchants.

16. A system for transmitting an optimized web link to a publisher, comprising:
a publisher interface computer module configured to:
receive a request for an affiliated web link corresponding to a merchant offering a product; and
transmit the affiliated web link to the publisher for display to a user;
a web link generation computer module communicatively connected to the publisher interface computer module configured to configure to:
generate the affiliated web link comprising:
a web address of the optimal merchant, and
a tracking code corresponding to the publisher;
a merchant interface computer module configured to:
receive from the optimal merchant an affiliated referral fee payment comprising:
one or more referral fees, and
a tracking code corresponding to each of the one or more referral fees; and
a referral fee allocation computer module configured to:
allocate to the publisher at least one of the one or more referral fees based on the tracking code.
